(19) United States
(12) Patent Application Publication
(10) Pub. No.: US 2020/0029714 A1
(43) Pub. Date: Jan. 30, 2020

(54) SMART WATER BOTTLE WITH ULTRAVIOLET RADIATION STERILIZATION

(71) Applicant: Hidrate, Inc., Minneapolis, MN (US)

(72) Inventors: Ngoc NGUYEN, Chicago, IL (US); Alexander HAMBROCK, Chicago, IL (US); Coleman IVERSON, Minneapolis, MN (US)

(21) Appl. No.: 16/590,955

(22) Filed: Oct. 2, 2019

Related U.S. Application Data
(63) Continuation of application No. PCT/US2018/026445, filed on Apr. 6, 2018.
(60) Provisional application No. 62/482,612, filed on Apr. 6, 2017.

(51) Int. Cl. A47G 23/16; C02F 1/32

(52) U.S. Cl. CPC A47G 23/16; C02F 1/325; C02F 2201/322; C02F 2307/02; C02F 2209/40; C02F 2209/42; C02F 2209/008

(57) ABSTRACT

The present disclosure is directed to smart, portable, reusable liquid containers, or container assemblies, with ultraviolet (UV) sterilization capability. An example container assembly includes a container defining a cavity to hold liquid. A cap coupled to the container prevents the liquid from spilling out of the cavity. A liquid level sensor and a processor track the amount of fluid within the container. When they detect liquid added to the container, they trigger one or more UV light sources for sterilizing the liquid. A cap sensor in or on the container assembly senses if the cap is on the container and prevents UV light source operation when the cap is off. The processor may communicate with a remote device, e.g., a smart phone or server, via an antenna. Indicators in or on the container assembly notify a user that UV sterilization is recommended, UV sterilization is in progress, etc.

### CROSS-REFERENCE TO RELATED APPLICATION(S)

This application claims priority, under 35 U.S.C. § 119(e), to U.S. Application No. 62/482,612, which was filed on Apr. 6, 2017, and is incorporated herein by reference in its entirety.

### BACKGROUND

Portable, reusable containers provide a convenient, low cost, and environmentally friendly means to store and consume water. However, if the container is not cleaned on a regular basis, bacteria from water or human saliva can build up over time, which can pose severe health risks that can result in illness. To combat bacteria build up in reusable containers, one well accepted solution is to expose the water in the container to ultraviolet (UV) radiation to sterilize the water. Past studies have shown that UV radiation can effectively kill or deactivate bacteria, thus sterilizing water without any need for chemicals, such as chlorine, or processes that require large amounts of energy, such as boiling.

For portable, reusable containers, UV sterilization provides a particularly attractive solution since water can be sterilized rapidly and UV systems typically are low weight and a small form factor. However, UV sterilization is typically deployed in suboptimal configurations. For example, in some instances, UV radiation is emitted from only a single location within the container, e.g., a UV source encapsulated in a lid, which can leave some portions of water within the container untreated due to absorption loss through other portions of water.

Furthermore, UV sterilization is also often performed with no external control where UV radiation is triggered on a fixed schedule without consideration of the operating environment e.g., when liquid levels in the container are low. This can lead to ineffective application of UV sterilization, resulting in unnecessary energy consumption and poor battery life. To improve the performance of UV sterilization in portable, reusable containers, sensors may be used to provide feedback on operating conditions, e.g., liquid level, environmental conditions, user profile, etc., in order to more efficiently apply UV sterilization in the treatment of drinking water.

### SUMMARY

Embodiments of the present technology include a container assembly and a method of using a container assembly comprising a container defining a cavity, a liquid level sensor, an ultraviolet (UV) light in optical communication with the cavity, and a processor operably coupled to the liquid level sensor and the UV light source. In operation, the cavity holds a liquid, and the liquid level sensor performs a measurement of a level of the liquid. The processor estimates or determines a change in the level of the liquid based on the measurement of the level of the liquid by the liquid level sensor. And the processor triggers illumination of the liquid by the UV light source based on the change in the level of the liquid to sterilize the liquid.

In some cases, the container is configured to prevent the UV light from escaping the cavity (e.g., it may be totally opaque or absorb or attenuate UV light). The container's inner surface may reflect the UV light within the cavity. The liquid level sensor may include a capacitive sensor, an ultrasonic sensor, or a mass sensor. The UV light source can be disposed on a substrate extending into the cavity. If so, the liquid level sensor may comprise a capacitive sensor disposed on the substrate extending into the cavity. And the processor can modulate a duration and/or an intensity of the illumination by the UV light source based on the change in the level of the liquid.

An example container assembly may also include an antenna, operably coupled to the processor, to receive a signal indicating a geographic location of the container assembly. In these cases, the processor may modulate a duration and/or an intensity of the illumination by the UV light source based on the geographic location of the container assembly.

The container assembly can also include a cap coupleable to the container and a cap sensor operably coupled to the cap and the processor. The cap keeps the liquid in the cavity, and the cap sensor detects that the cap is coupled to the container. And the processor can trigger the illumination of the liquid by the UV light source in response to the change in the level of the liquid and to detection of the cap coupled to the container by the cap sensor.

The container assembly may also include an accelerometer, operably coupled to the processor, to measure motion of the container. If so, the processor can determine that the container is stationary based on at least one measurement by the accelerometer and trigger the illumination of the liquid by the UV light source in response to the change in the level of the liquid and to determining that the container is stationary.

The container assembly may include a water quality sensor to detect an impurity in the liquid. If so, the processor can trigger the illumination of the liquid by the UV light source in response to detection of the impurity in the liquid.

And the container assembly can include a visible light source, operably coupled to the processor, to emit light visible to a user of the container assembly. The processor can actuate the visible source while the UV light source is emitting UV light, e.g., to notify the user that the UV light source is on.

Another embodiment of the present technology includes a container assembly comprising a container defining a cavity, a liquid level sensor disposed in the cavity, a processor operably coupled to the liquid level sensor, a UV emitting element operably coupled to the processor, and an antenna operably coupled to the processor. In operation, the cavity holds a liquid, the liquid level sensor measures a level of the liquid in the cavity, and the processor polls the liquid level sensor for a measurement of the volume of the liquid in the cavity. The processor also estimates a change in the level of the liquid in the cavity based on the measurement of the level of the liquid in the cavity. If the level has changed (e.g., increasing), the processor causes the UV light emitting element to sterilize the contents of the cavity and the antenna to transmit an indication of the change in the level of the liquid in the cavity to a wireless device, such as a smartphone.

Yet another embodiment includes a method of tracking consumption, by a user, of a liquid disposed within a container. This method comprises (A) measuring, with a liquid level sensor operably coupled to the processor, a volume of the liquid in the container; (B) estimating a change in the volume of the liquid in the cavity based on the volume of the liquid in the cavity; and (C) transmitting, via an antenna operably coupled to the processor, an indication of the change in the volume of the liquid in the container to a wireless device. If desired, steps (A) through (C) may be performed at periodic intervals. The method may also include initiating sterilization of the contents of the container on the basis of measurements of the change in volume of liquid in the cavity. And it can include receiving, via the antenna, an indication of a target change in the volume of the liquid and comparing, with the processor, the change in the volume of the liquid in the cavity to the target change in the volume of the liquid.

Still another embodiment includes a container assembly comprising a container to hold a liquid, a liquid level sensor, a UV light-emitting element, a processor operably liquid level sensor and the UV emitting element, and an antenna operably coupled to the processor. In operation, the container holds a liquid, the liquid level sensor measures a volume of the liquid, and the U V light-emitting element sterilizes the contents of the container. The processor (i) periodically determines a change in the volume of the liquid in the cavity based on the volume of the liquid measured by the liquid level sensor and (ii) periodically sterilizes the contents of the container. And the antenna transmits the change in the volume of the liquid to a wireless device.

Yet still another embodiment includes a fluid consumption monitoring and sterilization system comprising a housing configured to couple with a beverage container, a sensor coupled with said housing or that extends into said beverage container; a wireless communication interface coupled with the housing, a UV light emitting element coupled to the housing, a memory coupled with the housing, and a processor coupled with the memory and the wireless communication interface and situated in the housing. In operation, the processor receives sensor data from the sensor. It calculates at least one of an amount of fluid inside of, dispensed from, and/or added to the beverage container from the sensor data. The processor stores a representation of the amount of fluid in said memory and transmits the representation to an external device when a wireless communication channel is available to the external device.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a container assembly with UV elements, liquid level sensors, and electronics disposed inside a cap coupled to a container.

FIG. 1B shows a container assembly with a water quality sensor disposed inside the container cavity.

FIG. 1C shows a container assembly with a UV reflective layer on the interior surface of the cavity.

FIG. 2 shows a container assembly with UV elements, liquid level sensors, and electronics disposed in or on the base of the container.

FIG. 3 shows a container assembly with UV elements, liquid level sensors, and electronics disposed inside the container cavity.

FIG. 4 shows a container assembly with UV elements, liquid level sensors, and electronics coupled to an exterior surface of a container.

FIG. 5 shows a flowchart for sterilizing liquid in a container assembly based on (changes in) liquid level, geographic location, water quality, etc.

### DETAILED DESCRIPTION

### 1 A Smart Water Bottle that Triggers UV Sterilization Based on Liquid Level

The inventors have recognized that monitoring the consumption of water from a container makes it possible to adjust the timing of the UV sterilization to reduce the energy consumed by the UV light sources. For example, if the user pours out and replaces the liquid contents of the container, the new contents may be sterilized by an emission of low level ultraviolet radiation. Conversely, if the contents of the container have not changed in a given interval of time, repeated sterilization may be unnecessary and would waste energy.

An example smart water bottle reduces unnecessary energy consumption by triggering UV sterilization based on the level or amount of liquid that it contains. It has a liquid level sensor, flow meter, or other sensor that determines the level or amount of liquid that it holds or the change in the level or amount of liquid that it holds. A processor polls the liquid level sensor at intervals and, if it detects an increase in the liquid level, actuates one or more UV light sources to sterilize the liquid in the container.

The processor may also modulate the intensity and duration of the UV radiation emitted by the UV light sources based on the (change in) liquid level: if the liquid level has decreased, the processor may reduce the UV intensity, duration, or both to reduce energy consumption by the UV light source(s). And if the liquid level has increased, the processor may increase the UV intensity, duration, or both to ensure adequate sterilization of the added liquid. Similarly, if the UV lights are distributed throughout the bottle (e.g., running along a stick or probe extending into the container cavity that holds the liquid), the processor may trigger some UV lights but not others based on the liquid level. If the bottle is fill, the processor may turn all the UV lights on. Likewise, if the bottle is only partially full or nearly empty, the processor may turn on only those UV lights that are submerged or near the surface of the liquid.

The processor may also actuate the UV light source(s) based on the bottle's position, orientation, and/or motion. To do this, the processor polls an accelerometer that measures the bottle's acceleration. It determines the bottle's orientation and motion from the acceleration data provided by the accelerometer. If the processor determines that the bottle has not moved for a given period (e.g., several hours) based on the acceleration data, it may trigger sterilization by the UV light source(s) to inhibit bacteria growth. If the processor determines the bottle's orientation from the acceleration data, it may trigger certain UV lights and/or modulate the intensity and duration of the UV illumination accordingly. For instance, if the bottle is upside down and only half full, the processor may actuate the UV lights near the top of the bottle but not the bottom of the bottle.

The smart water bottle may include other sensors that can be used to trigger liquid sterilization by the UV light source(s). For instance, the smart water bottle may have a water quality sensor that senses impurities, such as bacteria or other microorganisms, in the liquid. If the water quality sensor indicates that the impurity levels are too high, the processor may turn the UV lights on at an intensity and duration intended to reduce the impurity levels to acceptable levels. Alternatively, or in addition, the smart water bottle may have an antenna, coupled to the processor, that receives location information from the Global Positioning System (GPS) or a GPS-enabled smartphone. If the location information indicates that the smart water bottle is in a part of the world where water quality is a concern, the processor may trigger more frequent, more intense, and/or longer UV illumination. The processor may also trigger sterilization in response to user commands received via the antenna or an actuator (e.g., a button), such as ad hoc commands or a schedule for UV sterilization.

An example smart water bottle may have a cap to prevent the liquid from spilling out of the container. It may also have a cap sensor, coupled to the processor, that detects when the cap is properly secured to the container. If the cap sensor detects that the cap has just been replaced, the processor may start sterilization, particularly if the liquid level sensor has detected an increase in the liquid level in the container. The processor may also automatically stop UV sterilization if the cap is being removed and prevent UV sterilization when the cap is off.

### 2 An Example UV Smart Water Bottle

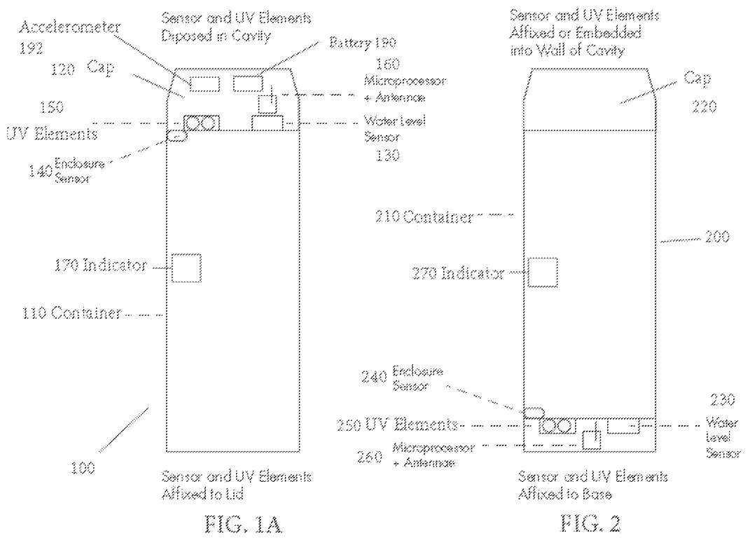

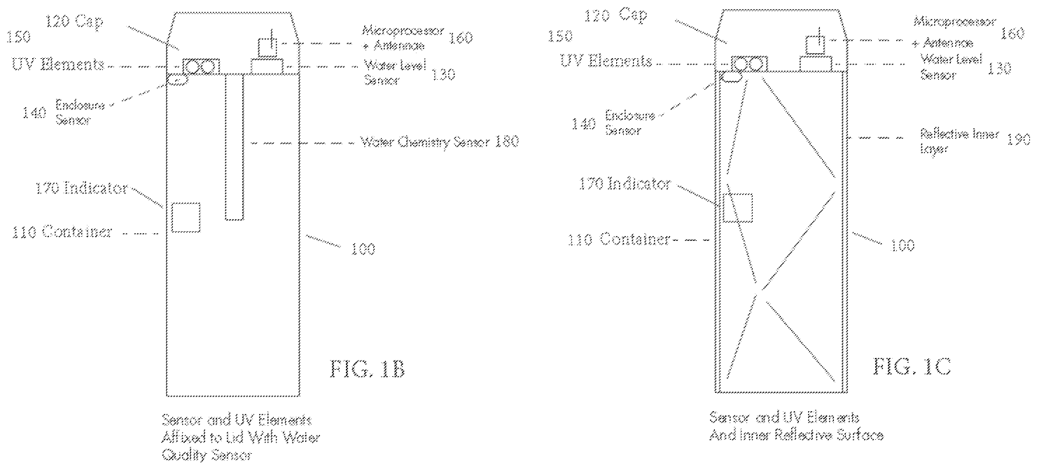

An exemplary embodiment of a UV smart water bottle, or container assembly 100, according to the present disclosure is shown in FIG. 1A. The container assembly 100 includes a container 110 having a sidewall, a closed bottom surface, and an open top surface that define a cavity, wherein liquid may be disposed within the cavity. To prevent liquid from unintentionally pouring out of the cavity, a cap 120 can be coupled to the open top surface of the container 110 to form a closed top surface. In the particular embodiment shown in FIG. 1A, a liquid level sensor 130 may be disposed in the cap 120 of the container assembly for monitoring the volume of liquid in the cavity of container 110. An enclosure sensor 150 may also be disposed proximate to the open top surface of container 110 to monitor the position of the cap 120, e.g., open or closed. One or more UV elements 140, such as UV light-emitting diodes (LEDs), can also be disposed in the cap 120 for sterilization of liquid upon entry or exit from container 110 or sterilization of liquid stored in container 110. A processor and antenna(e) 160 may also be disposed in the cap 120 to manage the operation of sensors, e.g., liquid level sensor 130, enclosure sensor 150, and accelerometer 192, or transducers, e.g., UV elements 140, in the container assembly 100 and to facilitate communication to remote devices via an antenna. The cap 120 may also contain a battery 190 or other power supply. A plurality of indicators 170, such as visible LEDs, may also be disposed in the container inside the cavity of the container 110 to provide indications on the status of the container assembly 100, e.g., UV sterilization is desired, UV sterilization is in progress, etc. In other embodiments, a water chemistry sensor 170 may also be included, as shown in FIG. 1B, to characterize the quality of water in the container 110.

### 3 Container

The container 110 may be comprised of a sidewall, a closed bottom surface, and an open top surface. The sidewall connects the closed bottom surface to the open top surface, forming a cavity, wherein liquid may be disposed and stored for consumption. The cross section of the cavity, defined along a plane parallel to the closed bottom surface and open top surface, may be circular, ellipsoidal, or polygonal in shape. The exterior cross section of the container 110 may similarly be circular, ellipsoidal, or polygonal in shape and may further differ from the shape of the cavity, which may indicate the sidewall thickness is variable or the container 110 is comprised of two separate components corresponding to the cavity and the exterior surface. Example designs appear in U.S. application Ser. No. 29/544,265, which is incorporated herein by reference. The open top surface may also include a plurality of coupling elements, such as a snap fit, press fit, helical grooves for twistable fastening, etc., to facilitate coupling of the cap 120 to the container 110 to form a sealed cavity.

The container 110 may further be configured to be opaque to UV radiation in order to prevent exposure of harmful UV radiation to a user during execution of a UV sterilization process. The opaqueness of container 110 can be achieved either by absorption of UV radiation from the container 110 or by reflection of UV radiation from the interior surfaces of the cavity in container 110. For example, in one embodiment, the interior surfaces of the cavity may be coated by a reflective layer, as shown in FIG. 1C, which not only prevents transmission of UV radiation through the container 110, but also more efficiently uses emitted UV radiation for sterilization by reducing absorption losses from the container 110. Additional coatings may also be applied to the exterior surface of the container 110 to increase UV opaqueness.

The container 110 may be configured to be opaque to UV radiation while remaining transparent to visible light. This shields the user from UV radiation and allows the user to see the liquid level at the same time. In instances where the container 110 is transparent to visible light, the sidewalls of the container 110 may be further configured to have varying levels of haze, which can affect the visual appearance of an indicator 170 disposed within the container 110. The container 110 may further be textured, patterned, embossed, or colored accordingly to known embodiments in the an.

The container 110 may be formed from a polymer, glass, metal, or any combination thereof depending on factors that include cost, longevity, thermal insulation, or weight. For example, in some embodiments, the container 110 may configured to have metallic sidewalls that form a vacuum insulation panel, e.g., a dewar, to maintain liquid in the container 110 at temperatures above or below ambient temperatures. Depending on the material used to form the container 110, a variety of manufacturing methods may be utilized to fabricate the container 110 including cold forming, injection molding, blow molding, or extrusion processes. Furthermore, the interior or exterior surfaces of the container 110 may also be coated to modify optical, chemical, or mechanical properties of the container 110 using methods such as spray coating or dip coating.

### 4 Cap

The cap 120, when coupled properly to the container 110, seals the cavity in container 110 to securely store a liquid disposed therein. The cap 120 may include one or more coupling elements, such as a snap fit, a press fit, or a corresponding plurality of grooves for twistable fastening (a screw top), to couple the cap 120 to the open top surface of container 110. In some embodiments, the cap 120 may be permanently attached to the container 110. In other embodiments, the cap 120 may be removable from the container 110 to facilitate cleaning of various constituent components in the container assembly.

The cap 120 may also include a secondary opening to facilitate consumption of liquids stored in the container 110. The secondary opening may include a protruding rim located on the periphery of the secondary opening to minimize spillage of liquid during consumption or pouring. A sealing gasket located on a lid may also be used to seal the secondary opening when not in use and may be manually actuated by a hinge, e.g., a rotatable lid. In other embodiments, the cap 120 may include a tube, which extends into the cavity of container 110 to further facilitate consumption of liquids. The tube may also be covered by a lid to seal the seconding opening of the tube. In these cases, the lid may be shaped to mate with the opening of the tube or the proximal end of the tube may be rotated, thus forming a valve to prevent liquid from exiting through the tube. According to the embodiments shown in FIGS. 1A though 1C, the cap 120 may also include a plurality of cavities and mounting elements for coupling sensors and transducers to the cap 120.

The cap 120 may also be configured to be opaque to UV radiation to reduce safety hazards associated with exposure to UV radiation. Similar to the container 110, the cap 120 may be opaque to UV radiation either by absorption of UV radiation from the cap 120 or reflection of UV radiation from the interior surfaces of the cap 120. The cap 120 may be further configured to be only spectrally opaque to UV radiation while allow visible light to transmit through. Coatings may also be applied to further reduce UV transmission through the cap 120.

The cap 120 may be formed from a polymer, glass, metal, or any combination thereof depending on factors that include cost, longevity, thermal insulation, or weight. Depending on the material used to form the cap 120, a variety of manufacturing methods may be utilized including cold forming, injection molding, blow molding, or extrusion processes. Furthermore, the interior or exterior surfaces of the cap 120 may also be coated to modify optical, chemical, or mechanical properties of the cap 120 using methods such as spray coating or dip coating.

### 5 Liquid Level and Fluid Flow Sensors

The liquid level sensor 130 may be comprised of a plurality of sensing elements mounted to a circuit board and encapsulated within a water tight enclosure to minimize exposure of the sensing elements to the liquid stored within the container 110. The liquid level sensor 130 may also be electrically coupled to the processor 160 and triggered by the processor 160 for measurement. The liquid level sensor 130 may be of any type of sensor configured to measure liquid levels including capacitive sensors, Hall-effect sensors, ultrasonic sensors, optical or infrared sensors, or weight/mass sensors.

Depending on the location and configuration of the liquid level sensor 130 in the container assembly, particular types of sensors may be more optimal than others. For example, according to the embodiments shown in FIGS. 1A through 1C, the liquid level sensor 130 may be disposed in the cap 120. In this instance, ultrasonic sensors that can detect liquid levels based on acoustic reflections from the surface of the liquid or optical sensors that can detect round trip absorption losses through the liquid may perform better than other sensors.

The container assembly 100 may also include a fluid flow sensor or flow meter (not shown) in addition to or instead of the liquid level sensor 130. This fluid flow sensor may be disposed in the cap 120 to monitor the flow rate of liquids entering and exiting the container 110. The fluid flow sensor be any type of sensor capable of measuring flow rates of liquids, including pressure-based flow meters, impeller systems, and so on. In some embodiments, the fluid flow sensor may be disposed proximate to the secondary opening of the cap 120. In other embodiments, fluid flow can be indirectly measured based on changes to liquid levels during a period of time.

For more information on suitable liquid level and fluid flow sensors, see, e.g., U.S. Pre-Grant Publication No. 2017/0340147 A1, entitled “Wireless Drink Container for Monitoring Hydration,” which is incorporated herein by reference in its entirety.

### 6 Cap Sensor

As described above, the cap 120 may include a secondary opening, which can be opened or closed manually. To avoid inadvertent exposure to UV radiation or to track fluid consumption, the cap 120 may include or be coupled to a cap sensor, or enclosure sensor 150, that monitors the state of the secondary opening in the cap 120. The enclosure sensor 150 may be any type of sensor configured to measure binary states, e.g., open or closed, including capacitive sensors, Hall-effect sensors, or mechanical switches. For example, the cap 120 may incorporate a magnet on the distal end of a rotatable lid configured to overlap with a Hall-effect sensor coupled near the secondary opening of the cap 120 when in a closed state. When the lid is opened, the magnet is positioned such that it no longer overlaps with the Hall-effect sensor, resulting in a change in voltage measured by the Hall-effect sensor.

As shown in FIGS. 1A through 1C, the enclosure sensor 150 may be disposed proximate to the open top surface of the container 110, which can enable monitoring of both a secondary opening of the cap 120 and removal of cap 120 for refill or cleaning. In other embodiments, the enclosure sensor 150 may be a different type of sensor capable of monitoring the cap 120 at a longer range (i.e., remotely). The enclosure sensor 150 can also be electrically coupled to the processor 160 and may also be encapsulated in a separate enclosure to avoid damaging the enclosure sensor 150 due to liquid or UV exposure.

### 7 Accelerometer

An accelerometer 192 may also be disposed in the container 110 or cap 120 to detect and track the motion and orientation of the container assembly. The accelerometer 192 may be a separate component coupled to the container assembly and electrically connected to the processor 160. The accelerometer 192 can also be integrated with the processor 160 to form a simpler, smaller electronics system.

The accelerometer may be used to trigger measurements of liquid levels using the liquid level 130 when the container 110 is in a stationary and upright position. The accelerometer 192 may also be used to determine when liquid is exiting or entering the container assembly, e.g., the container assembly is tilted at an inclined angle for several seconds for pouring or filling. The accelerometer 192 may also be used as a motion tracker to monitor user motion during physical activities, e.g., hiking, jogging, biking, and provide guidance to users when to consume liquids to maintain optimal hydration levels.

### 8 Water Quality Sensor and Other Sensors

The container assembly may also include a water quality sensor 180, as shown in FIG. 1C, to monitor the quality of liquids within the container 110. For example, the water quality sensor 180 may be a chemical sensor that detects the concentration of bacteria in the water or the mineral content of water. The water quality sensor 180 may include an exposed sensor element that interfaces directly with the liquid in the container 110 and electronics that are encapsulated in a water-tight enclosure. Data provided by the water quality sensor 180 can be used to trigger UV sterilization or provide users with a chemical profile of the quality of water in the container 110.

Other sensors may also be disposed in the container assembly to monitor various properties of the container and the liquid. For instance, in some embodiments, the container assembly may include a temperature sensor, a pH sensor, a clock, a sensor to detect the fluid type, and so on.

### 9 Processor and Antenna

The processor 160 may be comprised of electronics disposed on a circuit board and configured to operate and control the sensors and transducers in the container assembly. The processor 160 may also include or be coupled to an antenna to transmit and receive data from a remote device, such as a smartphone, tablet, or server. The antenna can be configured to transmit and receive using any method of data transmission including radio frequencies, Bluetooth, Wi-Fi, or any other methods known to one of ordinary skill in the art. The processor 160 may further be encapsulated within a water tight enclosure to reduce the likelihood of damage to the processor 160 from liquid in the container 110.

When paired with a smartphone or other remote device, the antenna may receive user commands and other information, including information about location and weather. The user commands may include commands to sterilize the liquid in the container as well as commands related to monitoring and prompting liquid consumption by the user. The location may indicate the container assembly's geographic location. Similarly, the weather information may indicate the local weather conditions, including the temperature and humidity. The processor 160 may use this information to trigger UV sterilization more or less frequently. For instance, if the location and weather information indicate the container assembly 100 is in a cold clime (e.g., the Arctic), the processor 160 may trigger UV sterilization less frequently to reduce power consumption. And if the location and weather information indicate the container assembly 100 is in a warm clime (e.g., the Tropics), the processor 160 may trigger UV sterilization more frequently to ensure that the liquid is sterilized.

The processor 160 can be configured to trigger, receive, and analyze data measured by the sensors and to perform an action using the transducers. For example, the processor 160 may be triggered to measure the liquid level using the liquid level sensor 130 when the accelerometer 192 detects the container assembly is stationary and in an upright position. Upon measuring the liquid level, the processor 160 may then activate the UV elements 140 for a duration and at an intensity selected to sterilize the liquid at the smallest possible or practical power consumption. During sterilization, the processor 160 may trigger the plurality of indicators 170 to emit and pulse with a certain hue and frequency to indicate sterilization is taking place. Following sterilization, the processor 160 may then transmit, via the antenna, a log of the UV sterilization to the remote device (e.g., a smartphone) for users to view. The processor 160 can also be triggered to perform UV sterilization under other conditions including readings from the water quality sensor 180, a preset schedule defined by an application or a user, when the accelerometer 192 doesn't detection motion for a preset period of time, and so on.

In other instances, the processor 160 can also monitor when the cap 120 is opened or closed and track the quantity of fluid entering or exiting the container assembly. This data can then be transmitted to the remote device to monitor user consumption of liquids, determine when the container assembly should be cleaned, and so on.

The processor 160 may also utilize data from the remote device or other sensors connected to the remote device, e.g., a user location, environment temperature, environment humidity, history of user physical activity, elevation, a user profile, etc. This data can be used by the processor 160 for additional functions such as providing visual indicators for when a user should consume liquids, when UV sterilization should occur under different environmental conditions.

### 10 UV Elements

The UV elements 140 may be comprised of at least one UV light source configured to emit short wavelength UV radiation capable of killing or deactivating bacteria. The UV light source may be any device capable of emitting UV radiation, including but not limited to LEDs, fluorescent lamps, discharge lamps, or laser diodes. The UV elements 140 may be further configured to operate in quasi continuous-wave, continuous-wave, or pulsed modes to modify the temporal energy profile of the UV light source based on varying levels of liquid in the container 110. The UV elements 140 may also emit UV radiation at varying levels of intensity selected to sufficiently sterilize a liquid without unduly or prematurely draining the battery 190 of the container assembly. Furthermore, the processor 160 may be operably coupled to the UV elements 140 via one or more electrical connections to control operation of the UV elements 140. As shown in FIGS. 1A through 1C, the UV elements 140 may be disposed in the cap 120 to illuminate liquid stored in the container 110 and liquid entering the container assembly through a secondary opening in the cap 120.

In some embodiments, the UV elements 140 may be operably coupled to various sensors in the container assembly using the processor 160 such that the UV elements 140 are triggered under certain conditions based on sensory feedback. For instance, if the liquid level sensor 130 detects a change in liquid level that exceeds a particular threshold, e.g., the container assembly is filled with water, and the enclosure sensor 150 indicates that the cap 120 is closed, the processor 160 may trigger the UV elements 140 to sterilize the liquid. In this manner, the UV elements 140 may not activate in regular intervals, but rather dynamically adapt to the conditions of the container assembly. Other triggers for the UV elements 140 include the water quality sensor 180 when bacterial levels are detected to exceed a particular threshold, the accelerometer 192 when the container assembly is detected to be stationary for a period of time, and the processor 140 based on geographic location. In other instances, the UV elements 140 may be manually activated by a user on demand or may activate according to a preset schedule, e.g., every 2 hours during the day.

The duration and intensity of UV radiation emitted from the UV elements 140 may also be dynamically modified according to different operating conditions. For example, when liquid levels are low, the UV elements 140 may be configured to emit a lower intensity of UV radiation for shorter durations in order to conserve battery life. The UV elements 140 may be also be operably coupled to the enclosure sensor 150 to shut off in the event the container assembly is opened during a UV sterilization process in order to prevent a user from being exposed to harmful UV radiation.

### 11 Indicators

One or more indicators 170, which can include visual, auditory, or vibration devices, disposed in the container assembly can provide users feedback on the state of the container assembly. For example, the indicators 170 may be comprised of a plurality of LEDs, which glow with a particular hue or in a particular pattern when UV sterilization occurs. The LEDs can also be used to indicate other states including when UV sterilization is appropriate, when the user should consume liquids to maintain optimal levels of hydration, when the container assembly should be cleaned, and so on. The indicators 170 may be disposed internally within the cavity of the container 110 in embodiments where the container 110 is transparent to visible light. And the indicators 170 may be disposed on the exterior of the container 110 in embodiments where the container 110 is opaque.

The indicators 170 can be electrically coupled to the processor 160 for power and control. Furthermore, the indicators 170 may be activated by the processor 160 in an automated manner according to conditions or states described above or based on custom states set by a user.

### 12 Other Embodiments

FIGS. 1A through 1C show one possible configuration of sensors and UV transducers in a container assembly. Other configurations are possible and may provide benefits under certain conditions. For example, in another embodiment shown in FIG. 2, a liquid level sensor 230, a UV elements 240, an enclosure sensor 250, and processor 260 may be disposed at the base of the container 210. By disposing sensors and transducers onto the container 210, the electrical assembly may be simplified since electrical connections no longer need to be maintained between the container 210 and a removable cap 220

In other embodiments, the UV elements and liquid level sensor may be distributed along the length of the container. Liquid level sensors distributed in this manner can measure liquid levels more accurately. A distribution of UV elements also provides a means to more uniformly the liquid, thus improving sterilization and further provides the possibility of spatially distributing UV radiation in regions of liquid, e.g., near the surface of the cavity, where bacteria growth may be more prevalent.

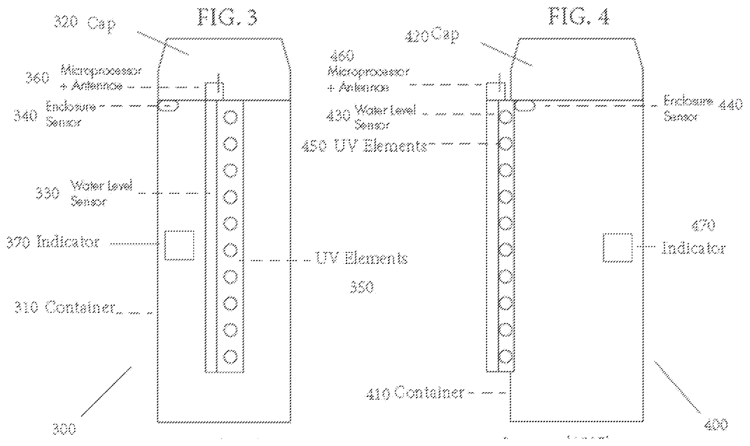

For instance, FIG. 3 shows a processor 360, a liquid level sensor 330, and UV elements 340 distributed and disposed inside the cavity of the container 310 to improve liquid level measurement and UV illumination. In this example, the liquid level sensor 330 is disposed along a stick or substrate that extends into the cavity defined by the container 310. This stick can extend from the cap (top down) or base (bottom up). And in FIG. 4, a processor 460, a liquid level sensor 430, and UV elements 440 may be distributed and disposed on the exterior surface of the container 410, e.g., using a neoprene sleeve with UV elements and liquid level sensors coupled therein, to simplify assembly and provide more reliable operation of liquid level measurement and UV sterilization. In these embodiments, the liquid level sensor 330/430 may include capacitive sensors disposed along the side of the container 310/410, e.g., as disclosed in U.S. Pre-Grant Publication No. 2017/0340147 A1, entitled “Wireless Drink Container for Monitoring Hydration,” which is incorporated herein by reference in its entirety.

### 13 A UV Sterilization Process for a UV Smart Water Bottle

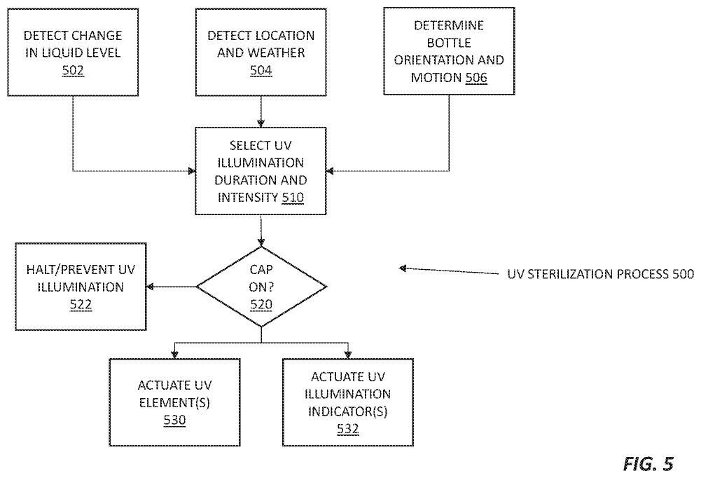

FIG. 5 illustrates a UV sterilization process 500 that can be implemented in the container assemblies (smart water bottles) shown in FIGS. 1-4. In step 502, the processor detects a change in the liquid level in the container based on one or more readings from a liquid level sensor or fluid flow sensor. The processor may also detect the container's location and local weather from a smartphone (step 504) and determine the container's orientation and motion from accelerometer data (step 506). Based on some or all of this information, as well as the time since the last UV illumination, the processor determines whether or not the liquid should be illuminated with UV radiation. If so, the processor determines the intensity and duration of the UV radiation, as well as which UV elements should be actuated to emit the UV radiation (step 510). If the cap sensor detects that the cap is on the container (step 520), the processor actuates the UV elements (step 530) and, optionally, UV illumination indicators (step 532). But if the cap sensor detects that the cap is not on the container (step 520), the processor turns the UV elements off if they are already on or prevents them from turning on if they are not on yet (step 522).

The steps shown in this process 500 can be performed in a variety of orders and/or simultaneously. For instance, the smart water bottle's processor may poll the cap sensor and liquid level sensor at regular intervals (e.g., every minute, five minutes, ten minutes, hour, etc.). They may also be done in iterative fashion. e.g., checking if the cap is on while illuminating the liquid with UV radiation.

### 14 Conclusion

While various embodiments have been described and illustrated herein, a variety of other means and/or structures for performing the function and/or obtaining the results and/or one or more of the advantages described herein is possible. More generally, all parameters, dimensions, materials, and configurations described herein are meant to be exemplary and that the actual parameters, dimensions, materials, and/or configurations will depend upon the specific application or applications for which the disclosed teachings is/are used. It is to be understood that the foregoing embodiments are presented by way of example only and that embodiments may be practiced otherwise than as specifically described and claimed. Embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

The above-described embodiments can be implemented in any of numerous ways. For example, embodiments of the technology disclosed herein may be implemented using hardware, software or a combination thereof. When implemented in software, the software code can be executed on any suitable processor or collection of processors, whether provided in a single computer or distributed among multiple computers.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the invention discussed above. The computer readable medium or media can be transportable, such that the program or programs stored thereon can be loaded onto one or more different computers or other processors to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, various disclosed concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein, the terms “about” and “approximately” generally mean plus or minus 10% of the value stated.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A. and at least one, optionally including more than one, B (and optionally including other elements); etc.

In the claims, as well as in the specification above, all transitional phrases such as “comprising,” “including,” “carrying,” “having” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures. Section 2111.03.

1. A container assembly comprising:
a container defining a cavity to hold a liquid;
a liquid level sensor to perform a measurement of a level of the liquid;
an ultraviolet (UV) light source, in optical communication with the cavity, to illuminate the liquid with UV light; and
a processor, operably coupled to the liquid level sensor and the UV light source, to estimate a change in the level of the liquid based on the measurement of the level of the liquid by the liquid level sensor and to trigger illumination of the liquid by the UV light source based on the change in the level of the liquid.

2. The container assembly of claim 1, wherein the container is configured to prevent the UV light from escaping the cavity.

3. The container assembly of claim 1, wherein the container has an inner surface configured to reflect the UV light within the cavity.

4. The container assembly of claim 1, wherein the illumination of the liquid by the UV light source sterilizes the liquid.

5. The container assembly of claim 1, wherein liquid level sensor comprises at least one of a capacitive sensor, an ultrasonic sensor, or a mass sensor.

6. The container assembly of claim 1, wherein the UV light source is disposed on a substrate extending into the cavity.

7. The container assembly of claim 6, wherein the liquid level sensor comprises a capacitive sensor disposed on the substrate extending into the cavity.

8. The container assembly of claim 1, wherein the processor is configured to modulate a duration and/or an intensity of the illumination by the UV light source based on the change in the level of the liquid.

9. The container assembly of claim 1, further comprising:
an antenna, operably coupled to the processor, to receive a signal indicating a geographic location of the container assembly.

10. The container assembly of claim 9, wherein the processor is configured to modulate a duration and/or an intensity of the illumination by the UV light source based on the geographic location of the container assembly.

11. The container assembly of claim 1, further comprising:
a cap, coupleable to the container, to keep the liquid in the cavity; and
a cap sensor, operably coupled to the cap and the processor, to detect that the cap is coupled to the container,
wherein the processor is configured to trigger the illumination of the liquid by the UV light source in response to the change in the level of the liquid and to detection of the cap coupled to the container by the cap sensor.

12. The container assembly of claim 1, further comprising:
an accelerometer, operably coupled to the processor, to measure motion of the container,
wherein the processor is configured to determine that the container is stationary based on at least one measurement by the accelerometer and to trigger the illumination of the liquid by the UV light source in response to the change in the level of the liquid and to determining that the container is stationary.

13. The container assembly of claim 1, further comprising:
a water quality sensor to detect an impurity in the liquid,
wherein the processor is configured to trigger the illumination of the liquid by the UV light source in response to detection of the impurity in the liquid.

14. The container assembly of claim 1, further comprising:
a visible light source, operably coupled to the processor, to emit light visible to a user of the container assembly,
wherein the processor is configured to actuate the visible source while the UV light source is emitting UV light.

15. A method comprising:
disposing a liquid in a cavity defined by a container;
sensing a change in a level of the liquid with a liquid level sensor; and
illuminating the liquid in the cavity with ultraviolet (UV) light in response to the change in the level of the liquid so as to sterilize the liquid.

16. The method of claim 15, further comprising preventing the UV light from escaping the cavity.

17. The method of claim 15, further comprising reflecting the UV light within the cavity.

18. The method of claim 15, wherein sensing the change in the level of the liquid comprises measuring the level of the liquid with a capacitive sensor disposed on the substrate extending into the cavity.

19. The method of claim 15, further comprising modulating a duration and/or an intensity of the UV light based on the change in the level of the liquid.

20. The method of claim 15, further comprising:
receiving, with an antenna operably coupled to the container, a signal indicating a geographic location of the container assembly; and
modulating a duration and/or an intensity of the UV light based on the geographic location of the container assembly.

21. The method of claim 15, further comprising:
sensing that a cap is coupled to the container; and
triggering the illuminating of the liquid in the cavity with the UV light while the cap is coupled to the container.

22. The method of claim 15, further comprising:
determining, with an accelerometer, that the container is stationary; and
triggering the illuminating of the liquid in the cavity with the UV light in response to determining that the container is stationary.

23. The method of claim 15, further comprising:
detect an impurity in the liquid; and
triggering the illuminating of the liquid in the cavity with the UV light in response to detecting the impurity in the liquid.

24. The method of claim 15, further comprising:
emitting visible light from a visible light source coupled to the cavity while the liquid is being illuminated with the UV light.

25. A container assembly comprising:
a container defining a cavity to hold a liquid;
a liquid level sensor, disposed in the cavity, to measure a volume of the liquid in the cavity;
a processor, operably coupled to the liquid level sensor, to poll the liquid level sensor for a measurement of the level of the liquid in the cavity and to estimate a change in the level of the liquid in the cavity based on the measurement of the level of the liquid in the cavity;
an ultraviolet (UV) light emitting element, operably coupled to the processor, to sterilize the contents of the cavity in response to the change in the level of the liquid in the cavity, and
an antenna, operably coupled to the processor, to transmit an indication of the change in the level of the liquid in the cavity to a wireless device.

26. A method of tracking consumption, by a user, of a liquid disposed within a container, the method comprising:
(A) measuring, with a liquid level sensor operably coupled to the processor, a volume of the liquid in the container;
(B) estimating a change in the volume of the liquid in the cavity based on the volume of the liquid in the cavity; and
(C) transmitting, via an antenna operably coupled to the processor, an indication of the change in the volume of the liquid in the container to a wireless device.

27. The method of claim 26, further comprising:
performing steps (A) through (C) at periodic intervals.

28. The method of claim 26, further comprising:
initiating sterilization of the contents of the container on the basis of measurements of the change in volume of liquid in the cavity.

29. The method of claim 26, further comprising:
receiving, via the antenna, an indication of a target change in the volume of the liquid, and
comparing, with the processor, the change in the volume of the liquid in the cavity to the target change in the volume of the liquid.

30. A container assembly comprising:
a container to hold a liquid;
a liquid level sensor, to measure a volume of the liquid;
an ultraviolet (UV) light emitting element, to sterilize the contents of the container
a processor, operably liquid level sensor and the UV light emitting element, to (i) periodically determine a change in the volume of the liquid in the cavity based on the volume of the liquid measured by the liquid level sensor, and (ii) periodically sterilize the contents of the container; and
an antenna, operably coupled to the processor, to transmit the change in the volume of the liquid to a wireless device.

31. A fluid consumption monitoring and sterilization system comprising:
a housing configured to couple with a beverage container;
a sensor coupled with said housing or that extends into said beverage container;
a wireless communication interface coupled with the housing;
an ultraviolet (UV) light emitting element coupled to the housing;
a memory coupled with the housing; and
a processor coupled with the memory and the wireless communication interface and situated in the housing and configured to:
receive sensor data from the sensor;
calculate at least one of an amount of fluid inside of, dispensed from, and/or added to the beverage container from the sensor data;
store a representation of the amount of fluid in said memory; and
transmit the representation to an external device when a wireless communication channel is available to the external device.
